(19) United States
(12) Patent Application Publication
(10) Pub. No.: US 2026/0189003 A1
(43) Pub. Date: Jul. 2, 2026

(54) NEUTRAL-FORMING TRANSFORMER MANAGEMENT

(71) Applicant: FORD GLOBAL TECHNOLOGIES, LLC, Dearborn, MI (US)

(72) Inventors: Haider Mhiesan, Canton, MI (US); Timothy Harris, Grosse Ile, MI (US); Kirk Pulay, Belleville, MI (US); Christopher Bernard Trombetta, Commerce Township, MI (US)

(21) Appl. No.: 19/336,995

(22) Filed: Sep. 23, 2025

Related U.S. Application Data
(60) Provisional application No. 63/739,980, filed on Dec. 30, 2024.

(51) Int. Cl. H02J 3/00

(52) U.S. Cl. CPC H02J 3/001

(57) ABSTRACT

A home energy system includes a neutral-forming transformer (NFT), one or more sensors, and a controller. The sensors monitor operating parameters associated with the NFT, such as temperature, voltage, and current. When the parameters satisfy a first condition for at least a first duration, the controller adjusts system load distribution to manage loading stress on the NFT. When the parameters satisfy a second, more elevated condition for at least a shorter, second duration, the controller opens an NFT relay to isolate the transformer.

### CROSS-REFERENCE TO RELATED APPLICATION

This application claims the benefit of U.S. provisional application Ser. No. 63/739,980, filed Dec. 30, 2024, the disclosure of which is hereby incorporated in its entirety by reference herein.

### TECHNICAL FIELD

This disclosure relates to managing electrical power distribution in home energy systems.

### BACKGROUND

Energy systems can include components such as transformers, relays, sensors, and controllers to manage electrical power distribution.

### SUMMARY

The disclosed method relates to operating a home energy system that includes a neutral-forming transformer (NFT). The method involves monitoring one or more operating parameters, such as temperature or current associated with the NFT, and performing different control responses based on how those parameters behave relative to multiple threshold values. When the parameter exceeds a first value for at least a first duration, the method performs a first control response, such as generating a user-facing notification. When the parameter exceeds a higher, second value for at least a shorter, second duration, the method performs a different control response, such as effecting a load-balancing redistribution associated with the NFT. In some embodiments, a third, more severe condition can trigger a third control response, such as isolating the NFT from one or more electrical conductors. These operations can involve relative threshold values tied to the NFT's operating capacity and are intended to manage conditions that may affect the NFT under varying load scenarios.

A home energy control system includes a controller programmed to manage operation of a neutral-forming transformer (NFT) based on temperature and voltage conditions associated with the NFT. When the measured temperature and voltage satisfy a first condition for at least a first duration, the controller toggles one or more loads linked to the NFT or adjusts load priorities across conductors to manage distribution. When the temperature and voltage instead satisfy a second, more elevated condition for at least a shorter, second duration, the controller opens an NFT relay of the home energy control system to isolate the transformer. In some embodiments, the temperature and voltage are measured using one or more sensors at or proximate to the NFT enclosure, and specific example conditions may include temperature and voltage ranges tied to the operational characteristics of the NFT.

A home power distribution system includes a housing with a neutral-forming transformer (NFT), one or more sensors for monitoring operating parameters of the NFT, and a controller programmed to manage system operation based on those parameters. When the measured operating parameters satisfy a first condition for at least a first duration, the controller adjusts the system's load distribution to reduce loading stress on the NFT. When the operating parameters instead satisfy a second, more elevated condition for at least a shorter, second duration, the controller opens an NFT relay to isolate the transformer. In some embodiments, the operating parameters include temperature, voltage, and current associated with the NFT, and example conditions may include specific temperature and voltage ranges or thresholds relative to the NFT's rated current. The controller can further prevent reclosing of the NFT relay until the operating parameters return to recovery values.

### BRIEF DESCRIPTION OF THE DRAWINGS

FIG. 1 is a schematic diagram of a home energy system including a neutral-forming transformer (NFT) and associated monitoring and control components.

FIG. 2 is a flowchart illustrating a method for monitoring NFT current and applying control actions based on defined current values and time durations.

FIG. 3 is a flowchart illustrating a method for monitoring NFT temperature and applying control actions based on defined temperature values and time durations.

FIG. 4 is a flowchart illustrating a method for monitoring NFT voltage and applying control actions based on defined voltage values.

FIG. 5 is a flowchart illustrating a method for monitoring both NFT temperature and voltage and applying control actions based on defined temperature-voltage combinations and time durations.

FIG. 6 is a flowchart illustrating a method for monitoring NFT current, temperature, and voltage and applying control actions based on defined multi-variable values and time durations.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Residential energy systems may include electrical infrastructure for supplying power to a variety of loads within a home or other dwelling. In many installations, these systems are configured to support both 240V and 120V loads, such as heating and cooling equipment, lighting, appliances, and personal electronics. A 240V supply may be provided across two conductors (commonly referred to as L1 and L2), and 120V operation may be supported through use of a neutral reference positioned between the conductors. In a conventional grid-connected installation, this neutral reference may be supplied by the utility via a grounded center tap of a distribution transformer. However, alternative configurations exist in which a utility-provided neutral is unavailable or not relied upon.

In certain residential or mobile environments, a dedicated neutral conductor may not be present. This condition may arise, for example, in systems operating in backup or off-grid modes, or in installations where power is supplied by sources that do not provide a grounded center tap, such as certain generators, electric vehicles, or standalone inverters. Such a condition may also be present in retrofit or modular deployments where full utility infrastructure is unavailable or bypassed. In such environments, the absence of a neutral reference may limit the system's ability to support 120V loads, which typically rely on a stable voltage midpoint between the L1 and L2 conductors.

To accommodate 120V load operation in systems without a dedicated neutral conductor, a neutral-forming transformer (NFT) may be employed. The NFT includes windings configured to generate a reference point between the L1 and L2 conductors, effectively establishing a local neutral. This arrangement allows 120V loads to be operated in conjunction with 240V loads using the same pair of supply conductors. The NFT may be installed within or proximate to a residential distribution panel and may support one or more branch circuits connected across the derived neutral and either of the supply conductors. In some implementations, the NFT operates in cooperation with a controller configured to monitor transformer behavior and manage loads in response to transformer operating conditions.

The NFT may operate as part of a home energy management system (HEMS) that is configured to coordinate energy sources, load demands, and electrical behavior within a residence. A HEMS may include one or more controllers, sensors, switching elements, and software routines coupled to grid connection points, local energy sources, and household loads. Power may be supplied from the grid, a generator, a bidirectional electric vehicle interface, a photovoltaic system, or any combination thereof. While the NFT itself is not a power source, it may be electrically coupled to such sources and may remain configured to establish a neutral reference across varying modes of operation. The HEMS may evaluate electrical conditions and influence system behavior to maintain compatibility with load types that rely on the NFT-derived neutral.

The present disclosure relates to a system in which the NFT is monitored and controlled based on its electrical operating state. In certain implementations, the HEMS may be configured to evaluate conditions such as transformer current, winding temperature, or voltage drop to determine whether the NFT is operating within a defined range. Based on these and potentially other parameters, the HEMS may perform an appropriate response based on one or more predefined logic controls. These responses may include commands to shift or reduce load, isolate or bypass the NFT, or take actions that influence system operation. In some cases, the control logic may evaluate the persistence, magnitude, or combination of operating conditions before initiating a response.

In certain implementations, the NFT may be electrically coupled to one or more monitoring elements configured to assess transformer operating conditions. These conditions may include electrical parameters such as NFT current, voltage drop, or winding temperature. The current may be measured as an absolute value or as a percentage of the NFT's rated capacity, and the voltage drop may be determined by comparing input and output potentials, or through differential measurement across winding terminals. Temperature measurements may be derived from one or more sensors in thermal communication with the NFT, such as thermistors placed near the windings. This information may be used by a system controller or other processing device to evaluate transformer state and determine whether specific operating values, thresholds, or conditions are met.

To evaluate transformer behavior and determine appropriate responses, the system may reference one or more logic-based decision routines. These routines may be stored as tables that associate monitored conditions with predefined actions and may be implemented in software, firmware, or other programmable logic. Each table may correspond to a particular monitored parameter (such as transformer current, winding temperature, or voltage drop) and may define multiple threshold levels for comparison. In some implementations, the system evaluates both the magnitude and persistence of a condition. For example, a moderate overcurrent sustained for a defined period may trigger a different action than a brief, high-magnitude spike. When a monitored value satisfies a threshold or condition defined in a table, the system may identify an associated response action for execution. These responses may include, for example, load modification, relay actuation, or changes to system control states.

In some implementations, the system may reference multiple action routines concurrently, with each routine independently evaluating its respective parameter against defined conditions. This allows the system to identify and respond to different types of transformer conditions, such as elevated current or increasing temperature, even if those conditions do not arise simultaneously. Alternatively or additionally, the routines may be interpreted hierarchically, with certain condition types or magnitude levels taking precedence over others. For example, transformer temperature conditions may override current-based logic, or a composite table evaluating multiple parameters in combination may supersede the individual parameter tables. When multiple thresholds are satisfied at once, the system may prioritize the most protective or restrictive action, select the action associated with the most elevated threshold, or apply a resolution scheme defined in the control logic.

When one or more parameters satisfy the conditions defined within the action tables, the system may initiate a corresponding control response. In some cases, the system may initiate load-shedding commands directed to specific devices or circuit branches, with the goal of reducing transformer burden. In other implementations, the system may control switching elements (such as relays positioned on the L1 and L2 conductors) to temporarily isolate the NFT from its electrical environment. Isolation may be applied in situations involving prolonged thermal stress or sustained voltage irregularities. Additional responses may include adjustments to load distribution, such as rebalancing loads across conductors, or selectively deactivating noncritical devices. In certain configurations, the system may include logic to delay, sequence, or conditionally reverse a control action after the triggering condition has cleared. This may allow the NFT to recover under reduced stress before full system operation is restored.

In addition to the individual action tables, the system may reference a composite table configured to evaluate multiple operating conditions in combination. This table may define response actions based on the concurrent presence of different operating conditions—such as elevated transformer temperature, high current draw, and measurable voltage drop—each of which may be evaluated separately or over partially overlapping time windows. The composite table may include logic that associates specific combinations of these conditions with graduated response actions, such as progressive load shedding or staged isolation of the NFT. In certain implementations, the composite logic may define stricter thresholds or shorter response windows when multiple conditions are simultaneously satisfied. This permits the system to account for compound electrical stress and enables more nuanced control strategies than would be available using individual condition tables alone.

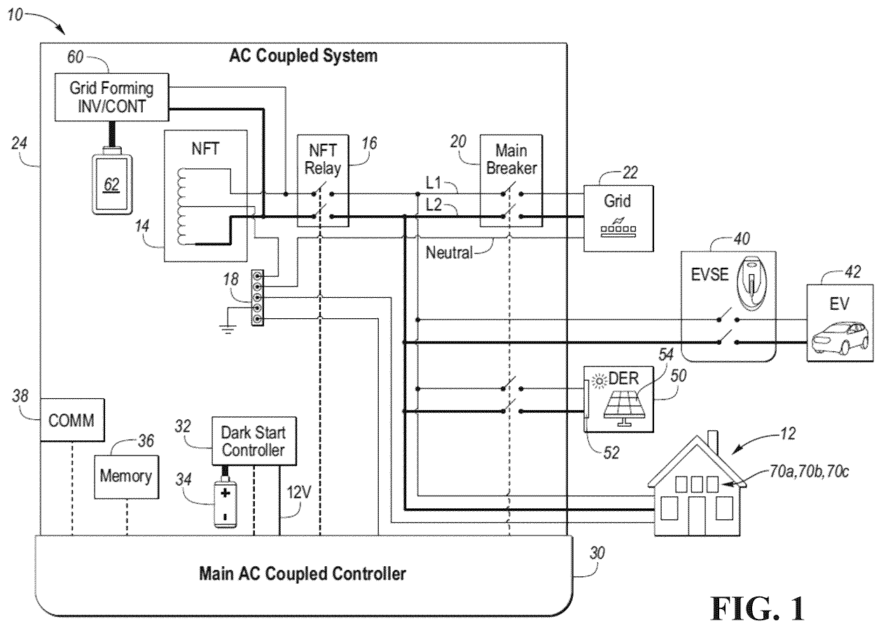

FIG. 1 illustrates an example implementation of a home energy system 10 configured to monitor and influence electrical behavior across multiple conductors supplying power to household loads. The system 10 may include power-handling infrastructure for distributing electrical energy throughout a building structure such as a residential home 12 and coordinating its flow among connected elements. In some configurations, the system 10 includes busbars, circuit protection devices, and interface terminals coupled to conductors supplying 120V and 240V branch circuits. The system 10 includes a neutral-forming transformer (NFT) 14 monitored by a controller 30 that initiates control actions based on transformer operating conditions, such as current, temperature, or voltage characteristics.

The home energy system 10 receives power from grid 22 and electrically interfaces with various local energy sources and loads. The grid 22 may deliver a split-phase 240V supply across two conductors, typically referred to as L1 and L2, with a grounded neutral center tap in conventional configurations. In the illustrated implementation, grid 22 provides a bidirectional interface with the system 10 such that energy may be delivered to or exported from the premises. In some implementations, energy delivered by the grid 22 is routed through a main breaker 20 and distributed via L1 and L2 conductors within the system 10. Loads coupled to these conductors may include devices requiring 240V across L1 and L2, or 120V between either conductor and a derived neutral, as discussed further below.

The main breaker 20 may serve as a primary disconnect device, permitting selective isolation of the home 12 from the grid 22. When closed, the main breaker 20 allows grid-supplied power to flow to loads, distributed energy resources (DERs), or storage elements within the system. During grid outages or intentional off-grid operation, the main breaker 20 may be opened to prevent backfeed or to enable islanded operation. The status of the main breaker 20 may also be used as an input to the controller 30, informing control logic related to transformer usage, load prioritization, or DER coordination.

A DER 50 may be electrically coupled to the home energy system 10 to supply or influence power flow within the residential environment. The DER 50 may take a variety of forms, including a photovoltaic (PV) system, a battery energy storage system (BESS), an engine generator, a fuel cell, a microturbine, or a bidirectional electric vehicle interface. In the illustrated implementation, the DER 50 is depicted as a PV system that includes a PV inverter 52 and a PV array 54. The PV inverter 52 may be configured to convert DC output from the PV array 54 into AC power for use within the system 10, and may be coupled to the AC bus 18 at a common coupling point.

In some system configurations, the DER 50 may operate in parallel with the grid 22, or may supply power to local loads during grid-disconnected conditions. DER output may vary dynamically based on generation or dispatch conditions and may contribute to current flow across the NFT 14. In some implementations, the controller 30 may monitor DER output directly (such as by sampling power output from the PV inverter 52 or evaluating power quality parameters at the coupling point) to determine whether DER activity contributes to transformer loading or asymmetry between the L1 and L2 conductors. Information from the DER 50 may be used in conjunction with transformer monitoring to identify load shifts, voltage imbalance, or other operational states requiring responsive action.

An electric vehicle (EV) 42 and associated electric vehicle supply equipment (EVSE) 40 may be connected to the home energy system 10 and participate in local power management activities. The EVSE 40 may support bidirectional power exchange, allowing the EV 42 to either consume or supply power based on system demands. In certain implementations, the EV 42 may provide supplemental power during grid outages or peak usage periods, or draw charging current during periods of surplus generation or low overall load.

The EV 42 and EVSE 40 may influence NFT 14 behavior by contributing to the aggregate electrical load, introducing current asymmetry, or affecting voltage conditions. High-power charging or discharging events may elevate transformer current or thermal stress, and changes in charging direction or intensity may introduce dynamic loading characteristics. The controller 30 may monitor the EV/EVSE interface to assess these effects in real time and incorporate this information into transformer oversight routines. Parameters such as charging state, power direction, and conductor-specific current levels may be evaluated alongside other transformer metrics to determine appropriate system responses.

The EV 42 and EVSE 40 are integrated elements of the home energy system 10 and may play an active role in smart NFT oversight. The controller 30 may coordinate EV operation with transformer loading conditions, for example by delaying or modulating charging behavior during high-load conditions, or by initiating vehicle discharge to offset asymmetrical loads or transformer stress. These capabilities enable the controller to implement more responsive and flexible control strategies in environments that include vehicle-based energy storage.

To support resilience during outages or interruptions, the home energy system 10 may include a dark start controller 32 for managing a dark start battery 34 to provide power to control circuits when grid voltage is absent. The system 10 may further include a grid-forming inverter 60 electrically coupled to a power source 62. The inverter 60 may supply AC power to conductors within the AC coupled system 10 when grid 22 is unavailable or insufficient. These components may enable continued operation of the system 10 in non-grid scenarios, allowing the NFT 14 to remain active and loads to be supplied from backup power when needed.

The home energy system 10 includes a Home Energy Management System (HEMS) 24. The HEMS 24 (also referred to as a “HEMS hub 24” or “combiner box”) acts as an integration and coordination point for external and local energy resources and includes various control, sensing, and switching components configured to evaluate electrical conditions and influence system behavior. Components of the HEMS 24 may be housed within a common enclosure or housing that may be weatherproof, thermally managed, or segmented to separate high-voltage and low-voltage compartments. The HEMS 24 includes pass-through or grommeted cable routing for accommodating L1, L2, Neutral, and ground conductors, along with low-voltage wiring for battery connections, control signals, and communications. Internally, the combiner box may include terminal blocks, busbars, relays, fuses, or printed circuit boards configured to support interconnection and coordination of the components within the system 10. In some embodiments, the HEMS 24 further includes circuitry for monitoring voltage and frequency conditions on the AC bus 18. The integration of sensors, relays, and processing logic within HEMS hub 24 provides a localized environment for responsive decision-making and coordinated system oversight.

The controller 30 of the HEMS 24, also referred to herein as “HEMS controller 30,” serves as a central coordination unit for relays, power sensing, load distribution, transformer performance, grid interaction, and general energy flow management. The HEMS controller 30 is configured to coordinate operation of the system 10 based on measured electrical conditions and predefined control logic. The HEMS controller 30 may include processing hardware, memory, and associated software or firmware instructions enabling it to execute logic routines, reference stored action tables, and initiate control responses. These responses may include controlling relays, influencing load distribution, initiating NFT isolation, or communicating with other system components such as DERs or vehicle charging interfaces. The HEMS controller 30 may monitor parameters such as transformer temperature, current draw, and voltage drop, either directly or through associated sensors, and may determine whether one or more predefined values, thresholds, or combinations of conditions are met.

While the HEMS controller 30 is illustrated as being integrated within the HEMS hub 24, this physical arrangement is not limiting. In other implementations, the controller 30 may be positioned elsewhere within the home 12 or may be remote from the premises altogether. For example, certain aspects of the control logic may be executed by a cloud-based platform, with the controller 30 operating as a distributed control system that coordinates local measurements and actions with remote decision-making resources. This flexibility allows the control functions associated with NFT monitoring and load coordination to be implemented using a variety of hardware topologies, including configurations with centralized, decentralized, or hybrid control architectures.

The HEMS controller 30 may include processing hardware configured to operate in conjunction with a memory 36 storing logic routines, parameter values or thresholds, and other control instructions. The memory 36 may comprise a non-transitory computer-readable medium storing instructions that, when executed by the controller 30, cause it to perform the control and coordination operations described herein. These operations may include initiating transformer isolation, influencing load distribution, or controlling relays based on measured electrical conditions.

The memory 36 may reside locally within the same housing as the controller 30, such as within the HEMS hub 24, or may be located remotely and accessed via wired or wireless communication. In some implementations, the memory 36 may be cloud-accessible, enabling updates to control logic or threshold values over time. Regardless of location, the memory 36 provides the programmable basis for the system's decision-making capabilities. In this way, upon determining one or more predefined values, thresholds, or combinations of conditions are satisfied, the controller 30 may initiate actions stored in the memory 36.

The HEMS controller 30 may further include or be operatively coupled to a communication interface 38 configured to enable data exchange between the controller and other system components, as well as external or remote entities. The communication interface 38 may support wired or wireless communication protocols, and may be used to receive updated control logic, action tables, or firmware updates from a cloud-based service. In some implementations, the interface 38 also facilitates interaction with a mobile application or utility server, allowing monitored parameters or system states to be reported and reviewed. The communication interface 38 may also enable remote access to configuration settings or user-defined operational preferences, further extending the adaptability of the smart NFT control framework.

In configurations supporting cloud-based functionality, the communication interface 38 may maintain a data link between the HEMS controller 30 and a remote server environment. This connectivity may allow operational data, such as transformer loading trends, control actions taken, or threshold event histories, to be uploaded for long-term storage, analytics, or diagnostic purposes. In some cases, the cloud platform may support system updates, allowing the controller 30 to receive modified action tables, revised logic structures, or updated firmware in response to new operating conditions or customer preferences. Cloud connectivity may also enable over-the-air commissioning, user profile management, or the coordination of multiple distributed systems within a property or fleet.

The NFT 14 of the HEMS 24 is electrically coupled between the L1 and L2 conductors and configured to generate a neutral reference used for supporting 120V loads within the home 12. In the illustrated configuration, NFT 14 is installed downstream of the NFT relay 16 and positioned to serve branch circuits requiring a midpoint voltage between the two supply lines. The NFT 14 includes windings arranged to create a stable reference potential that effectively divides the 240V supply into two 120V paths, allowing devices connected between the derived neutral and either L1 or L2 to operate with conventional single-phase voltage levels.

The presence of NFT 14 within the home energy system 10 enables compatibility with load types that rely on a neutral reference, particularly in installations where no utility-provided neutral is available. This may be relevant in backup power modes, mobile environments, or systems supplied by sources such as inverters or electric vehicles. By forming a local neutral, the NFT 14 supports flexible load operation across a variety of installation types and supply scenarios.

In some implementations, the NFT 14 may be thermally and electrically monitored to assess ongoing operating conditions. The NFT 14 may include or be associated with one or more temperature sensors placed in proximity to the windings, as well as current and voltage sensing elements to evaluate transformer load and potential drop. These measurements may be communicated to the controller 30 of the HEMS 24, which may analyze the data in accordance with predefined logic routines or action tables. Depending on detected conditions (such as excessive current, elevated temperature, or voltage irregularities), the controller 30 may initiate appropriate control responses involving load adjustment, NFT isolation, or other system actions.

An NFT relay 16 of the HEMS 24 is configured to selectively connect or disconnect conductors, such as the L1 and L2 lines feeding the NFT 14 or associated loads. The NFT relay 16 may be used to isolate the NFT 14 in response to detected operating conditions or to redirect power flows based on system logic. In some cases, the NFT relay 16 may be a solid-state device, mechanical contactor, or hybrid unit configured to respond to control signals issued by the controller 30.

The home energy system 10 is configured to supply electrical power to a variety of loads (e.g., loads 70a, 70b, and 70c) connected across the L1 and L2 conductors. These loads may represent residential appliances, lighting circuits, heating and cooling equipment, personal electronics, or other devices requiring either 120V or 240V operation. Some loads may be connected line-to-line across L1 and L2 to receive 240V service, while others may draw 120V between either L1 or L2 and the neutral reference established by the NFT 14.

In some implementations, individual loads may be associated with control or sensing elements that enable their behavior to be influenced or monitored. For example, certain loads may be equipped with controllable interfaces (such as smart switches, circuit-level relays, or programmable outlets) that permit the HEMS controller 30 to initiate load modification in response to transformer stress or imbalance. Additionally, current or voltage sensors positioned along the L1 and L2 branches may provide real-time information on load behavior, which can inform logic-based control decisions. Although the specific load types and arrangements may vary, the system 10 is generally configured to identify, evaluate, and influence load activity as part of a coordinated response strategy aimed at preserving transformer stability and extending operational viability in environments lacking a utility-supplied neutral.

The HEMS 24 may further serve as a central signaling and control hub, interfacing with other components in system 10. For example, the controller 30 may be communicatively connected to the EVSE 40 or DER 50 to receive operational status, power availability, or charging readiness signals. In embodiments where vehicle state of charge (SOC) data is made available to the system 10, the HEMS 24 may receive such information from the EVSE 40 and determine whether to enable or delay charging. The HEMS 24 may also coordinate energy flow logic by activating or deactivating system relays in response to changing DER output, vehicle connection status, or homeowner-specified operating modes.

As discussed, the home energy system 10 includes one or more sensing elements configured to monitor electrical conditions associated with the NFT 14 and the loads it serves. These sensing elements may be positioned within the HEMS hub 24 or in proximity to other components, such as transformer windings or conductor terminals. In some implementations, sensors are used to measure transformer winding temperature, load-side current, and voltage characteristics across the L1 and L2 conductors. This information may be processed by the controller 30 to determine whether electrical conditions fall within acceptable operating ranges.

For example, a temperature sensor may be in thermal communication with the NFT 14 and provide real-time data indicative of transformer heating under asymmetric or sustained loading conditions. Current sensors may measure flow through L1 and L2 independently, allowing the controller 30 to evaluate loading balance. Voltage sensing may be used to detect drops across conductor paths or to monitor the presence of an active AC signal under varying conditions. In some cases, these measurements are used individually; in others, the system 10 may analyze combinations of parameters to identify compound stress or emerging imbalance. The sensing framework enables condition-driven decision-making in support of transformer coordination, protection, and load management.

The components described above form a coordinated and modular home energy system 10 in which a controller 30 monitors transformer behavior, evaluates electrical conditions, and initiates control actions in response to system state. The NFT 14 operates in conjunction with conductors L1 and L2 to support both 120V and 240V loads 70a, 70b, and 70c, which may be distributed across the home 12. The controller 30 receives input from sensors monitoring transformer current, winding temperature, and voltage conditions, and references stored logic to determine whether load shaping, NFT isolation, or other control actions are appropriate.

While the components of the system 10 are configured to operate under a wide range of electrical conditions, real-world usage can introduce variations that place changing demands on the neutral-forming transformer 14. Unlike static infrastructure, household electrical behavior is dynamic and shaped by user activity, environmental conditions, and source variability. Loads may fluctuate rapidly or remain energized for extended durations, and distributed energy resources may inject power in unpredictable patterns. These evolving conditions can influence transformer temperature, current draw, and voltage characteristics over time. As such, beyond passive operation, effective coordination of the NFT 14 may involve responsive evaluation of real-time electrical behavior to maintain system compatibility.

In residential environments configured with L1 and L2 supply conductors, power distribution may become unbalanced as different devices activate on different legs. For example, certain lighting or appliance circuits may draw current primarily from L1, while others may operate from L2. If high-power devices are energized on one conductor but not the other, a current asymmetry may develop across the NFT 14. Because the NFT 14 serves to establish a neutral reference between these conductors, such imbalances can affect transformer behavior, including the magnetic loading of its windings and the resulting internal temperature rise. Although some degree of asymmetry is expected in ordinary operation, sustained or pronounced imbalances may produce elevated transformer stress, particularly when coinciding with high load conditions. Accordingly, the system 10 is configured to monitor current distribution across conductors and may initiate control actions if asymmetry exceeds a defined threshold or persists over time.

Distributed energy resources (DERs) 50, such as photovoltaic systems, generators, or bidirectional vehicle interfaces, may introduce additional considerations to transformer behavior. In certain cases, DERs 50 may operate intermittently or with variable output. When supplying power to downstream loads, a DER 50 may alter voltage characteristics or shift the power balance between L1 and L2 conductors. In some scenarios, DER contribution may increase transformer current or amplify conductor asymmetry, particularly when the DER output is not symmetrically distributed or coordinated with grid input. As a result, the presence of a DER 50 may contribute to variations in current draw, voltage drop, or thermal loading at the NFT 14. The system 10 may therefore monitor both DER operation and transformer response to determine whether control actions are appropriate based on predefined logic conditions.

Furthermore, over time, residential energy systems may undergo changes in electrical topology, component mix, or load characteristics. These changes may include the addition of new appliances, replacement of legacy systems with higher-efficiency models, or installation of supplemental DERs 50 such as PV arrays or backup generators. In some cases, modular or retrofit energy products may be introduced without comprehensive integration considerations, resulting in system configurations that differ from original design assumptions. These shifts may alter the electrical demands placed on the NFT 14 or influence how current is drawn across conductors. As a result, previously acceptable operating conditions may evolve into sustained or recurring electrical patterns that stress the NFT 14. To accommodate such evolution, system 10 may include control logic for assessing ongoing transformer behavior and adjusting control strategies accordingly. This allows the NFT monitoring and response logic to remain effective in systems that experience gradual or stepwise reconfiguration.

In addition to electrical dynamics, the thermal and physical environment surrounding the NFT 14 may influence its operational behavior. Factors such as ambient temperature, enclosure ventilation, and installation proximity to heat-generating components can affect the transformer's ability to dissipate heat. For example, an NFT 14 installed in a low ventilation panel or in an exterior cabinet exposed to direct sunlight may exhibit higher baseline operating temperatures than one located in a temperature-controlled interior space. Physical installation variables such as conductor gauge, terminal torque, or enclosure spacing may also affect current-handling capacity or thermal performance. Because these conditions may not be reflected in static system specifications, the HEMS controller 30 may rely on real-time temperature measurements and adaptive logic to evaluate transformer performance. This enables the system 10 to respond to situational variations in transformer heating, current flow, or voltage behavior that arise due to environmental or installation-specific factors.

The smart NFT system incorporates a logic-based control framework configured to monitor transformer behavior and initiate control responses based on defined electrical conditions. This framework is executed by the HEMS controller 30, which may reference a collection of predefined logic routines or constructs (also referred to herein as “action tables”) to associate detected electrical states with associated control actions. These action tables may be implemented through software, firmware, or programmable logic instructions and are accessible by the controller 30 as part of its real-time decision-making process.

Each action table defines a set of values, thresholds, or condition groupings corresponding to monitored parameters, such as transformer temperature, current draw, or voltage deviation. When the controller 30 receives sensor input reflecting present electrical conditions, it may evaluate that input against one or more action tables to determine whether an action should be taken. If a relevant value, threshold, or condition is satisfied, the associated response logic is triggered. The controller 30 may then instruct relays 16, modify load states, or initiate other control responses as appropriate to the detected condition.

This logic-driven structure allows the system 10 to detect and respond to transformer behavior dynamically and without requiring constant user intervention. Rather than hard-wiring a fixed response to each potential condition, the use of configurable action tables provides a modular and scalable approach to transformer oversight, permitting a range of behavioral inputs to be correlated with tailored response strategies.

To evaluate transformer behavior and identify potential operating concerns, the controller 30 monitors one or more electrical parameters associated with the NFT 14 and its surrounding electrical environment. These parameters may include transformer current draw, voltage drop across winding terminals, and transformer temperature. In some configurations, the controller 30 may also assess conductor imbalance or load asymmetry as indicators of uneven system loading.

Current draw may be measured along the L1 and L2 conductors using current transformers or other sensing elements positioned upstream or downstream of the NFT 14. In some implementations, these measurements may be normalized relative to the NFT's rated current-handling capability to allow threshold-based logic referencing a percentage of rated load. Similarly, voltage drop may be determined by comparing the input and output voltages of the NFT 14, either through direct differential measurements or calculated from terminal values. Persistent deviations in voltage drop may suggest elevated impedance or emerging electrical degradation within the transformer.

Temperature monitoring may be implemented using one or more thermistors, resistance temperature detectors, or similar temperature-sensitive elements placed in thermal communication with the NFT 14. These may be positioned near transformer windings or within the transformer enclosure to provide representative data under both transient and sustained load conditions. Temperature data may be used in conjunction with current and voltage readings to assess thermal loading and cumulative electrical stress. In some implementations, the controller 30 may apply time-based averaging or filtering to distinguish short-duration anomalies from sustained conditions requiring intervention.

The measurements described herein may be processed locally within the HEMS hub 24 or transmitted to a remote processing environment. The monitored parameters provide the basis for control logic execution, including comparison to one or more predefined values or thresholds stored in memory 36. By continuously evaluating these electrical indicators, the controller 30 can identify developing trends, recognize threshold crossings, and initiate appropriate responses using the logic routines described below.

The control behavior of the HEMS controller 30 may be guided at least in part by a set of programmable logic routines stored in memory 36. These routines may include a series of logic-based action tables that associate specific operating conditions of the neutral-forming transformer 14 with corresponding control responses. Each table may be structured as a lookup or rule set that the controller 30 references in real time to evaluate measured electrical parameters and determine whether a predefined condition or combination of conditions has been satisfied.

In certain configurations, the action tables may be implemented in software, firmware, or programmable logic, and may be stored locally within the HEMS hub 24 or in a remote system accessible to the controller 30 via communication interface 38. The action tables may be preloaded during system installation or may be updated after deployment through local configuration or cloud-based synchronization. The tables may define multiple condition-response pairs, allowing for nuanced system behavior tailored to the capabilities of the NFT 14, expected load profiles, or site-specific goals.

Each action table may correspond to a particular monitored parameter. For example, one table may define control responses for transformer current conditions, while another addresses transformer temperature, and another evaluates voltage drop across the NFT 14. Within each table, multiple threshold levels may be defined, each associated with a specific range or magnitude of the parameter being monitored. Some implementations may further incorporate timing logic, such that a condition must persist for a defined period before a response is triggered. This approach allows the system to differentiate between transient events and sustained operating deviations.

In addition to independently evaluated parameter tables, the system may include a composite table (referred to in some examples as a “dissociation table”) that evaluates combinations of parameters in parallel. This table may associate concurrent or overlapping threshold conditions (e.g., elevated temperature and current draw) with graduated response actions. The composite structure allows the system to recognize compounding effects and initiate more restrictive or preemptive control actions when multiple stress indicators are present simultaneously.

When the controller 30 references the tables during operation, it may do so either in parallel or with a defined evaluation hierarchy. In a parallel evaluation scheme, each action table is interpreted independently, and a response may be triggered by any one condition being met. Alternatively, a hierarchical logic model may assign priority to certain condition types, such as temperature-based limits overriding current-based thresholds. The controller 30 may also apply a rule resolution strategy; for example, executing the action associated with the most restrictive entry, combining actions, or deferring to a composite logic outcome when multiple tables are satisfied.

The control responses defined in the action tables may include commands to actuate relays 16, shift or reduce loads 70a-70c, isolate the NFT 14 from supply conductors, or otherwise influence the electrical behavior of system 10. These responses may be implemented automatically by the controller 30 or coordinated with other components such as DER 50 or EVSE 40. In some configurations, action tables may be user-defined or adjustable, enabling site-specific customization of control behavior based on transformer rating, environmental factors, or energy use priorities.

The control responses associated with the action tables may vary depending on the nature, magnitude, and persistence of the monitored condition. In some scenarios, the response may involve temporary or partial adjustments, while in others, more assertive action may be taken to preserve transformer operability or overall system performance. For example, when transformer current exceeds a defined value or threshold for a brief period, the controller 30 may initiate partial load reduction, such as deactivating one or more loads 70a-70c determined to be noncritical or least energy-intensive. If current remains elevated or increases beyond a higher threshold, the system may escalate its response, shedding additional loads or deactivating loads on a particular conductor (e.g., L1 or L2) to address potential imbalance.

In other situations, temperature rise or voltage drop across the NFT 14 may prompt protective intervention. For instance, sustained transformer winding temperature above a predefined value may trigger a relay command to temporarily isolate the NFT 14 using relays 16. This may serve to allow thermal conditions to normalize before re-engaging the transformer in active service. Similarly, voltage irregularities, such as an abnormal drop between the NFT input and output, may suggest excessive burden or imbalance, prompting responsive reconfiguration of connected loads or activation of a cooldown delay.

Responses may also be time-based or conditionally reversed. In some cases, after a load-shedding or isolation event is triggered, the controller 30 may initiate a timer or recheck loop to evaluate whether recovery values or conditions have been met or achieved. These may include returning transformer temperature or current to acceptable thresholds for a defined duration, successful reconnection of DER 50 or EV 42 sources, or confirmation that load symmetry across L1 and L2 has been restored. When appropriate, the system may then automatically re-engage previously shed loads or reclose relays 16 to resume standard operation.

The system may also incorporate coordination logic that evaluates which control path achieves a suitable system adjustment. For example, the controller 30 may assess whether rebalancing loads across L1 and 12 achieves greater effect than full load deactivation, or whether multiple small-scale interventions, such as selectively cycling appliances or adjusting EVSE 40 charging rates, are preferable to a single disruptive response. In such cases, the logic encoded in the control routines may weigh transformer protection against user-defined energy priorities, as stored in the memory 36 or received via the communication interface 38.

In addition to the independently evaluated action tables described above, the system may reference one or more composite tables, referred to in some examples as dissociation tables, configured to evaluate multiple operating conditions in combination. Such composite tables associate combinations of transformer parameters with corresponding control responses. For instance, a composite table may define progressively restrictive actions based on concurrent detections of elevated temperature, high current draw, and voltage drop, even if those conditions are not individually sufficient to trigger action under their respective parameter-specific tables.

A composite table allows the system to recognize compound operating states that suggest increased transformer strain or deviation from nominal behavior. In some implementations, the composite table may incorporate timing logic that evaluates whether certain parameters have persisted for overlapping or consecutive time windows, thereby distinguishing between brief anomalies and sustained stress conditions. This approach enables the system to identify electrical behaviors that may not rise to actionable levels when considered in isolation, but that warrant intervention when viewed in combination.

Control responses associated with a composite table may mirror those triggered by single-parameter evaluations, such as load reduction, relay actuation, or NFT isolation, but may be initiated earlier or more aggressively due to the perceived cumulative effect. A composite table may also define response prioritization or escalation logic in the event that multiple condition groupings are satisfied. In this way, the system is able to tailor control behavior not only to discrete parameter values or thresholds, but to the broader context of transformer operation and system dynamics.

To further illustrate the logic framework discussed above, a series of action tables are provided herein. Each table defines one or more electrical parameters monitored by the HEMS controller 30, along with associated response actions triggered when corresponding conditions are satisfied. These tables represent example implementations of programmable control logic. Variations in threshold levels, time windows, or response strategies may be adapted based on system configuration, transformer characteristics, or user preferences.

Each action table may be implemented in the form of a software structure, rule set, or other data representation accessible by the controller 30. The tables may define multiple threshold levels for a given parameter, such as transformer current, winding temperature, or voltage drop, and associate those thresholds with actions such as load shedding, relay actuation, or NFT isolation. In some implementations, tables may further specify persistence conditions or timing intervals, such that a given parameter must exceed its threshold for a specified duration before an action is initiated.

Table 1 presents an example action table corresponding to transformer current monitoring. The HEMS controller 30 may measure or receive current values associated with operation of the NFT 14, expressed as a percentage of the transformer's rated capacity. These current values may be continuously or periodically sampled and evaluated to determine whether predefined thresholds are met. In some cases, the current should exceed a given level for a minimum duration before an associated control response is initiated. Each row in Table 1 defines a current value or threshold, a minimum persistence time, and a corresponding control response. The thresholds are expressed as percentages of rated transformer current, while the time column specifies how long the threshold must be sustained before the action is applied. The example actions shown here include progressive load shedding and, in some cases, full isolation of the NFT from the supply conductors.

TABLE 1

| NFT Current (%) | Time (min) | Control Response |
|---|---|---|
| 70-80 | 20 | Action 1 |
| 80-90 | 5 | Action 2 |
| 90-100 | 1 | Action 3 |

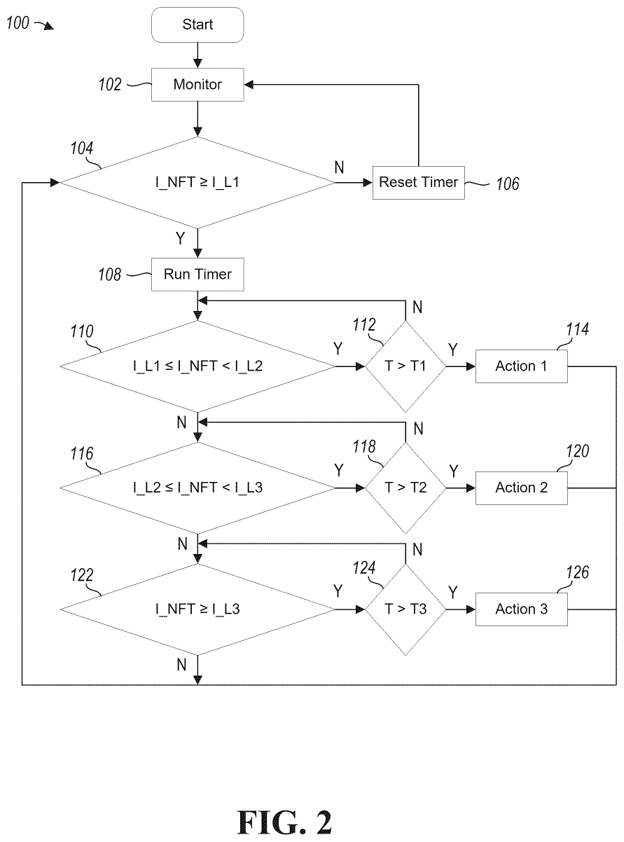

Referring now to FIG. 2, a method 100 is illustrated for evaluating transformer current and determining appropriate control responses under conditions of sustained load. This logic sequence is executed by the HEMS controller 30, which monitors current flowing through the NFT 14 using sensors integrated within or adjacent to the transformer housing. The monitored current reflects the aggregate electrical demand placed on the system, and therefore provides a valuable diagnostic signal for assessing transformer utilization and identifying abnormal load behavior.

In general, current values below 70% of the NFT's rated capacity are treated as indicative of normal load conditions; i.e., balanced and sustainable household operation without transformer overburden. However, when the monitored current exceeds this lower threshold, the system transitions into a protection and management mode defined by a tiered response logic. The example implementation shown in FIG. 2 corresponds to the threshold values in Table 1, which define current bands I_L1, I_L2, and I_L3 representing 70%, 80%, and 90% of the NFT's rated current, respectively. For each current band, the table specifies a corresponding minimum persistence time—T1 (20 min), T2 (5 min), and T3 (1 min)—during which the elevated current must be sustained before the system triggers a corresponding control action.

At step 102, the system begins monitoring current draw through the NFT 14. If the current does not satisfy the condition I_NFT≥I_L1 at step 104, the system resets a timer at step 106 to T=0.

When the measured current I_NFT is determined at step 104 to satisfy the condition I_NFT≥I_L1, the system proceeds to Run Timer at step 108. The system them proceeds to determine which subsequent elevated current draw condition is satisfied.

When the measured current I_NFT is determined at step 110 to satisfy the condition I_L1≤I_NFT<I_L2, the system proceeds to determine a condition persistence time at step 112. If the current remains within this band for a time T≥T1, the system initiates Action 1 at step 114.

Action 1 involves generating a first-level imbalance indication or alert. The controller 30 may transmit a notification to a user-facing interface, such as a wall-mounted display, a mobile app, or a visual indicator on the HEMS hub 24, informing the user of a sustained moderate load imbalance. The system may optionally activate relay 16 or similar switching hardware to perform preliminary load redistribution, such as toggling non-critical loads or shifting load priority across L1 and L2 conductors.

If, instead, the monitored current satisfies I_L2≤I_NFT≤I_L3, as determined at step 116, the system proceeds to determine a condition persistence time at step 118. If the elevated condition persists for T≥T2, the system triggers Action 2 at step 120.

Action 2 represents an escalated alert level. The system may reinforce the earlier alert through a more urgent notification or audible tone, and initiate intensified load balancing through the HEMS controller 30. This may include dynamic reassignment of discretionary loads, preferential disabling of lower-priority devices, or cycling off devices known to drive asymmetry. Relay 16 or other actuators may be used to reduce current asymmetry or offload selected circuits.

When the current rises to or above I_L3 (e.g., ≥90%), as determined at step 122, the system proceeds to determine a condition persistence time at step 124. If the condition persists for at least T3, the system initiates Action 3 at step 126.

Action 3 is a protective isolation response. The system may automatically open relay 16 or other circuit interrupters to isolate the NFT 14 from both the L1 and L2 conductors, thereby relieving transformer burden and preventing thermal or mechanical degradation. This isolation may be implemented as a full disconnection or a partial circuit separation. Simultaneously, the controller may log a diagnostic trouble code (DTC) for future analysis, and issue an urgent system-level notification to the user interface. The system may optionally initiate cooldown procedures or restrict reconnection until conditions return to acceptable levels.

If, during timer execution, the measured current I_NFT drops below the lower bound of the evaluated band (e.g., below I_L1 during T1 monitoring, or below I_L2 during T2 monitoring), the timer may be reset at step 106, and the system returns to baseline monitoring at step 102.

The tiered logic described herein permits graduated control responses depending on transformer loading magnitude and persistence. By evaluating both magnitude (I_NFT) and duration (T) of transformer stress, the system can distinguish between transient spikes or anomalies and sustained overload conditions, ensuring that actions such as load shedding or NFT isolation are reserved for persistent deviations rather than momentary anomalies.

While transformer current provides an important indicator of load imbalance and system burden, other operating conditions may also signal emerging stress within the electrical environment. One such condition is transformer temperature, which may correlate with sustained electrical demand, suboptimal load distribution, or adverse ambient conditions. To complement the current-based control strategy described above, the system may therefore implement additional monitoring logic focused on thermal behavior.

Table 2 presents a set of control responses based on transformer temperature, as detected or estimated by one or more sensors within or near the neutral-forming transformer 14. These responses are triggered when measured transformer temperature exceeds predefined thresholds for corresponding time durations. In the illustrated example, the HEMS controller 30 monitors NFT temperature and evaluates its behavior over time, comparing observed values against the threshold levels Temp_L1 (e.g., 100° C.), Temp_L2 (e.g., 120° C.), and Temp_L3 (e.g., 130° C.). Each row of the table reflects a temperature band, a minimum persistence duration, and an associated control response, ranging from initial alerts to more assertive actions. These values may be representative of transformer thermal tolerances in a typical residential system, but may be adapted to suit specific installations.

TABLE 2

| NFT Temperature (° C.) | Time (min) | Control Response |
|---|---|---|
| 100-120 | 20 | Action 4 |
| 120-130 | 5 | Action 5 |
| >130 | 1 | Action 6 |

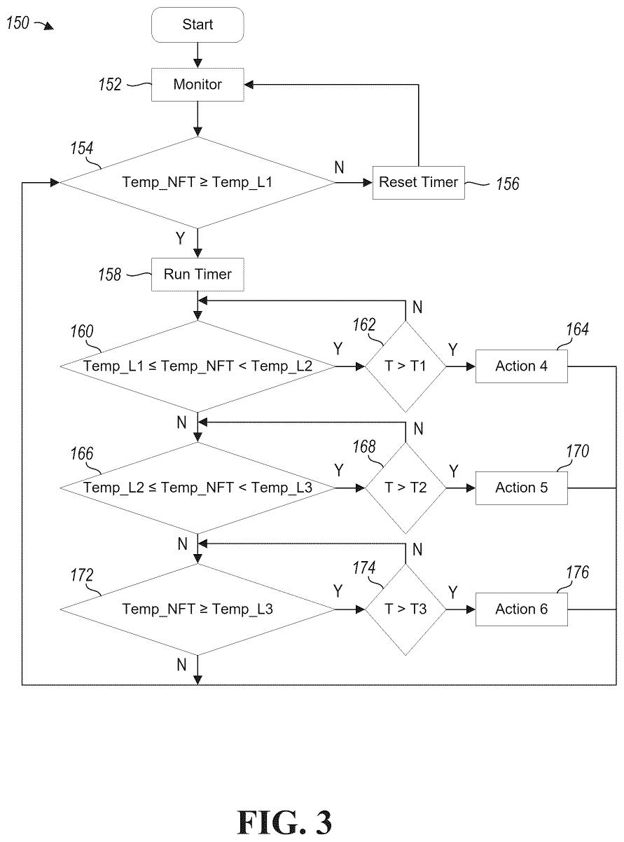

Referring now to FIG. 3, a method 150 is shown for identifying elevated transformer temperature conditions and executing appropriate control actions based on the values or thresholds defined in Table 2. This routine may be performed by the HEMS controller 30 as part of an ongoing monitoring process, using internal or external temperature sensing components to estimate thermal stress on the NFT 14. The method 150 evaluates whether measured temperature values persist above defined thresholds for a minimum time interval, and, if so, initiates one of the responses listed in Table 2, with Actions 4 through 6 representing escalating system responses to sustained temperature increases. As with other control routines, the thresholds and durations may be adjusted according to system design, transformer specifications, or operating conditions.

At step 152, the system monitors the temperature of the NFT 14. This value may be determined using embedded thermistors, resistance temperature detectors (RTDs), or other suitable temperature sensors, and may reflect the winding, core, or enclosure temperature of the transformer. The measured temperature is compared against a set of predefined thresholds that define operating bands of interest.

At step 154, the controller determines whether the measured temperature Temp_NFT exceeds a threshold temperature value (e.g., 100° C.). If the measured temperature does not satisfy the condition Temp_NFT≥Temp_L1, the system resets a timer at step 156 to T=0.

When the measured temperature Temp_NFT is determined at step 154 to satisfy the condition Temp_NFT≥Temp_L1, the system proceeds to Run Timer at step 158. The system them proceeds to determine which subsequent elevated condition is satisfied.

When the measured temperature satisfies the condition Temp_L1≤Temp_NFT≤Temp_L2 at step 160, corresponding to a moderately elevated temperature band (e.g., 100-120° C.), the method proceeds to step 162 where the controller 30 determines how long the temperature remains within this band. If the condition persists and T>T1 (e.g., more than 20 minutes), as determined at step 162, the system proceeds to step 164 and executes Action 4. Action 4 may involve issuing an overtemperature alert, notifying the user or remote monitoring interface, and optionally initiating modest thermal mitigation such as targeted load shifting, activation of local cooling functions, or preemptive adjustments to load profiles.

If, instead, the monitored temperature satisfies the next elevated band, Temp_L2≤Temp_NFT<Temp_L3 (e.g., 120-130° C.), as determined at step 166, the method advances to step 168, where the timer is observed to determine the persistence of this condition. If T>T2 (e.g., more than 5 minutes), the method 150 proceeds to step 170 and executes Action 5. Action 5 reflects an escalated mitigation strategy that may include aggressive load shedding, staged isolation of selected circuits via relay 16, and automated notifications or diagnostics to prioritize human intervention. The system may also increase the urgency or visibility of prior alerts.

If, instead, the monitored temperature satisfies the next elevated band, NFT_Temp≥Temp_L3 (e.g., 130° C.), as determined at step 172, the method advances to step 174, where the timer is observed to determine the persistence of this condition. If T>T3 (e.g., more than 1 minute), the method 150 proceeds to step 176 and executes Action 6. Action 6 represents a shutdown response: the controller 30 may fully disconnect the NFT 14 from the AC bus 18 by opening relay 16, trigger a diagnostic trouble code (DTC), and log fault data for further analysis.

In addition to current and temperature, the HEMS controller 30 may monitor voltage levels associated with the NFT 14 to identify emerging signs of electrical imbalance or instability. Voltage behavior, particularly sustained reductions below nominal levels, can signal asymmetry in conductor loading, improper coordination with local DERs, or early signs of transformer stress not yet reflected in thermal or current measurements. Accordingly, the system may implement a separate voltage monitoring routine to evaluate these conditions and initiate corresponding actions when defined voltage thresholds are breached.

Table 3 presents example control thresholds and corresponding response actions that are triggered when the measured output voltage of the neutral-forming transformer (NFT) drops below one or more predefined levels. Each row defines a voltage band and an associated control response.

TABLE 3

| Voltage Drop (V) | Control Response |
|---|---|
| 119-118 | Action 7 |
| 117-116 | Action 8 |
| <116 | Action 9 |

Unlike the current- and temperature-based tables previously described, the responses defined in Table 3 do not require a minimum persistence time. Instead, the voltage level alone serves as the triggering condition. As shown, three voltage bands are defined, with example thresholds of 119V, 118V, and 116V, respectively. Each band corresponds to a progressive system response based on the magnitude of the voltage drop.

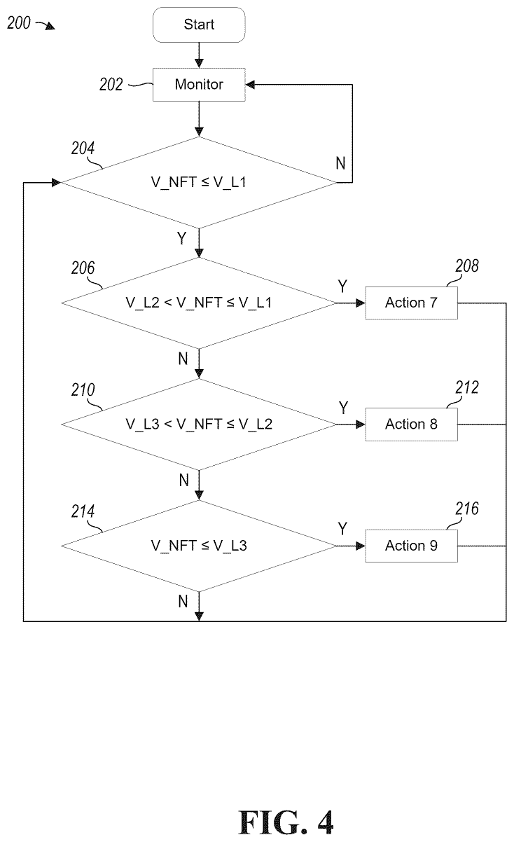

FIG. 4 illustrates a method 200 for evaluating voltage conditions at the NFT 14 and identifying appropriate control responses according to the logic of Table 3. The method 200 may be executed by the HEMS controller 30 and operates continuously to assess whether voltage measurements fall within any of the defined response bands.

Method 200 begins at step 202, where the HEMS controller 30 monitors the voltage level at the NFT 14. This voltage, denoted V_NFT, is continuously sampled via suitable voltage sensors located on the transformer input or supply conductors.

At step 204, the controller 30 determines whether the monitored voltage satisfies the condition V_NFT≤V_L1, where V_L1 represents a first threshold (e.g., 119V). If this condition is not met, the process returns to step 202 for continued monitoring. If the condition is met, the method proceeds to step 206.

At step 206, the controller 30 evaluates whether the monitored voltage falls within a first voltage band: V_L2<V_NFT≤V_L1, where V_L2 may correspond to a voltage such as 118V. If so, the system executes Action 7 at step 208.

Action 7 may include issuing a notification or alert that a minor voltage drop has occurred, such as via a user notification on a mobile app. The controller 30 may also initiate a diagnostic check or request a DER power increase, if one is available, to bolster voltage support.

If the condition at step 206 is not satisfied, the method proceeds to step 210, where the system checks for a second voltage band: V_L3<V_NFT≤V_L2, with V_L3 defined, for example, as 116V. If this condition is met, the controller initiates Action 8 at step 212.

Action 8 may include more assertive measures to counteract the voltage drop, such as curtailing noncritical household loads (e.g., smart appliances 70a-70c) or re-routing DER output more directly to priority circuits. Additional user alerts may also be generated.

If the condition of step 210 is not met, the controller proceeds to step 214, where it evaluates whether V_NFT≤V_L3. This condition corresponds to a voltage deviation sufficient to warrant Action 9 at step 216.

Action 9 may initiate immediate protective actions, such as opening NFT relay 16 to prevent transformer overload and isolating sensitive DERs or EVSE units from the system to prevent backfeeding. A diagnostic event may also be logged, and the system may issue a high-priority alert to the user for immediate investigation.

If none of the above conditions are met, the method returns to step 202, where voltage monitoring continues.

In addition to the individual monitoring routines described above (each evaluating transformer current, temperature, or voltage independently), the system may incorporate multi-parameter logic to identify conditions that emerge through the interaction of two or more variables. These implementations may reference composite action tables, which define response criteria based on combinations of electrical parameters and their persistence over time. For example, certain fault conditions may only become apparent when both temperature and voltage deviate in tandem, or when elevated current draw coincides with low voltage, indicating a compounded system imbalance. By analyzing such multi-variable states in parallel, the controller 30 may assess transformer stress and initiate responses tailored to correlated patterns of degradation. The following table illustrates one such implementation in which transformer temperature and voltage are monitored simultaneously.

Table 4 presents an example composite action table in which transformer temperature and voltage are jointly evaluated to identify stress conditions not evident when monitoring either parameter alone. A decline in voltage may indicate excessive loading, DER misbehavior, or asymmetric conductor conditions, while elevated temperature reflects internal thermal stress. When these factors arise together (such as a sustained voltage drop during a thermal event), the system may infer a degradation state and perform escalated response actions. By correlating these indicators over time, the controller 30 can distinguish between routine thermal drift and potentially deficient operating conditions.

TABLE 4

| NFT Temperature | Voltage | Time | Control |
|---|---|---|---|
| (° C.) | Drop (V) | (min) | Response |
| 100-120 | 119-118 | 20 | Action 10 |
| 120-130 | 117-116 | 5 | Action 11 |
| >130 | <116 | 1 | Action 12 |

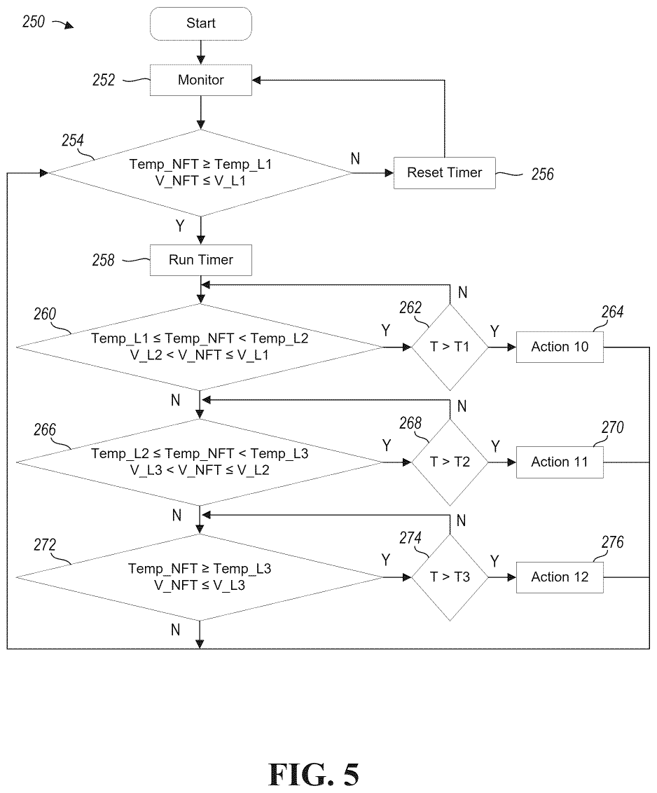

Referring now to FIG. 5, a method 250 is illustrated for detecting compounded stress conditions at the NFT 14 based on both temperature and voltage drop. This logic is executed by the HEMS controller 30, which concurrently monitors transformer temperature and voltage using suitable sensors embedded within or adjacent to the NFT housing. Method 250 implements the threshold-response structure defined in Table 4, evaluating whether combined thermal and voltage deviations persist beyond minimum time thresholds, and issuing one of the defined control actions (Actions 10-12) accordingly.

At step 252, the system monitors the NFT temperature and voltage, denoted Temp_NFT and V_NFT, respectively. These values may be acquired through dedicated temperature sensors (e.g., thermistors or RTDs) and voltage sensors coupled to the transformer's supply or output terminals.

The method proceeds to step 254, where the controller 30 evaluates whether the measured conditions satisfy a basic elevated threshold: Temp_NFT≥Temp_L1 and V_NFT≤V_L1. This condition indicates that both temperature and voltage have deviated from normal operating levels, potentially signaling stress on the transformer. If this condition is not met, the system proceeds to step 256 to set or reset the timer to T=0, and then returns to the monitoring step 252. In doing so, the system prevents triggering unnecessary control responses in cases where anomalies are transient or quickly resolve on their own.

If both the temperature and voltage conditions are satisfied at step 254, the method advances to step 258, where the system begins (or continues) running a timer to track how long the stress condition persists. The method then progresses through a series of evaluations to determine whether any defined combination of temperature-voltage stress bands has been met for a sufficient duration to trigger an associated control response.

At step 260, the controller checks whether the measured values fall within the first intermediate band: Temp_L1≤Temp_NFT<Temp_L2 and V_L2<V_NFT≤V_L1. If this compound condition is met, the method advances to step 262, where the timer is checked to determine whether the condition has persisted for more than T1 (e.g., 20 minutes). If so, the system executes Action 10 at step 264.

Action 10 represents a first-level composite notification. The controller 30 may generate a combined overtemperature and voltage drop alert, notifying the user via the HEMS hub interface or a connected app. Load redistribution routines may be initiated to alleviate both temperature and voltage concerns; for example, shifting high-current loads to alternate conductors, prioritizing less thermally intensive devices, or coordinating DER output to stabilize voltage.

If the condition of step 260 is not satisfied, the method proceeds to step 266, which evaluates the next elevated condition: Temp_L2≤Temp_NFT≤Temp_L3 and V_L3<V_NFT≤V_L2. This represents a state in which both temperature and voltage further deviated from nominal values. If the band is matched, the method advances to step 268 to determine whether the condition has persisted beyond T2 (e.g., 5 minutes). If so, the controller executes Action 11 at step 270.

Action 11 corresponds to an escalated composite response. The HEMS controller 30 may intensify thermal mitigation and voltage support efforts. This may include curtailing specific loads known to exacerbate transformer heating, issuing more prominent or time-sensitive alerts to the user, or staging automatic disconnection of non-critical circuits. DER output may be coordinated more aggressively to bolster line voltage.

If neither of the preceding conditions are satisfied, the method proceeds to step 272, where it checks for an even further escalated condition: Temp_NFT≥Temp_L3 and V_NFT≤V_L3. If both of these limits are exceeded (e.g., Temp≥130° C. and V≤116 V), the system moves to step 274 to determine if the critical condition persists beyond T3 (e.g., 1 minute). If so, the system executes Action 12 at step 276.

Action 12 represents a protective system shutdown. The controller 30 may immediately open relay 16 to isolate the NFT 14, thereby preventing potential transformer inoperability. This action may be accompanied by the logging of a diagnostic trouble code (DTC), issuance of a high-priority fault notification, and optional delay or lockout of transformer reconnection until normal conditions are restored.

If none of the conditions at steps 260, 266, or 272 are met, the method returns to the initial evaluation step 254, where monitoring continues and the system remains in an elevated awareness state until the stress condition is resolved or escalates.

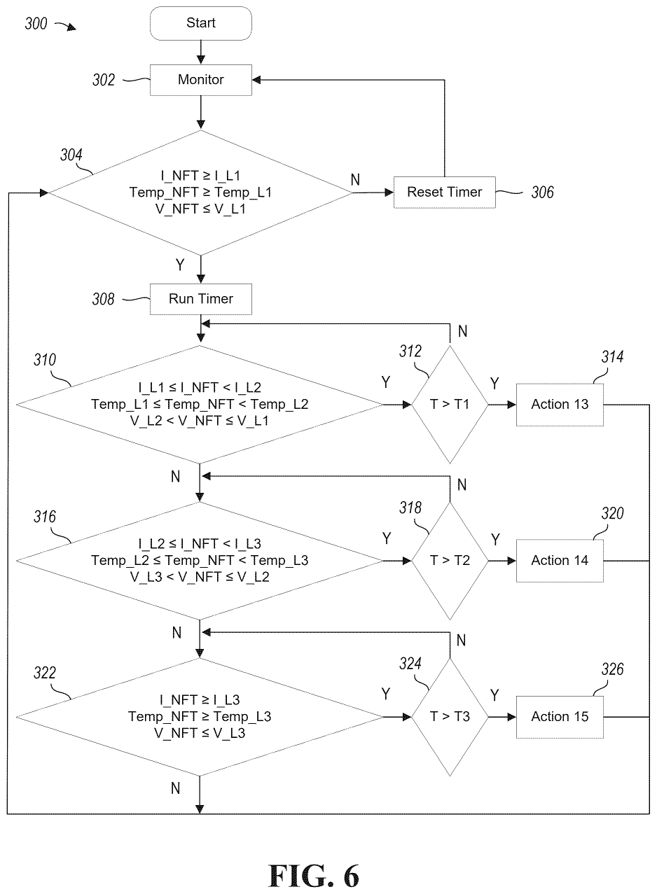

As a further refinement to system diagnostic and response logic, a composite approach may be employed in which three or more independent operating parameters are evaluated in tandem. While the preceding routines monitor transformer current, temperature, or voltage individually or in coordinated pairs, certain conditions may warrant more complex logic to capture the intersection of multiple stress indicators. By analyzing combinations of electrical current draw, internal temperature, and voltage deviation, the system can identify not only that the transformer is under strain, but also why and how urgently a response is needed. This multidimensional framework allows for tailored mitigation strategies that distinguish between benign anomalies, compound load imbalances, and precursors to critical conditions. Table 5 and the method of FIG. 6 exemplify this expanded logic layer, defining tiered control responses that engage when specific combinations of current, temperature, and voltage persist for minimum durations.

TABLE 5

| NFT Current | NFT Temp. | Voltage | Time | Control |
|---|---|---|---|---|
| (%) | (° C.) | Drop (V) | (min) | Response |
| 70-80 | 100-120 | 119-118 | 20 | Action 13 |
| 80-90 | 120-130 | 117-116 | 5 | Action 14 |
| 90-100 | >130 | <116 | 1 | Action 15 |

Referring now to FIG. 6, a method 300 is illustrated for identifying operating conditions involving a combined assessment of transformer current, temperature, and voltage, and initiating corresponding control responses. This routine reflects the threshold bands defined in Table 5, and may be executed by the HEMS controller 30 as a higher-order logic layer used when multi-parameter monitoring is enabled. The method diagnoses compound stress states, such as elevated load, thermal accumulation, and undervoltage conditions occurring simultaneously, and applies tiered control responses that reflect the magnitude and persistence of the detected imbalance.

At step 302, the controller monitors three parameters in parallel: current draw through the NFT 14, its internal temperature, and the associated voltage level on the supply lines. These values may be determined using current sensors, thermal probes (e.g., thermistors or RTDs), and voltage taps positioned at or near the NFT terminals.

At step 304, the controller evaluates whether all three measured parameters exceed their respective base values or thresholds: Temp_NFT≥Temp_L1, I_NFT≥I_L1, and V_NFT≤V_L1. This combination represents an initial trigger point for composite overload detection. If the condition is not satisfied, the system proceeds to step 306, where the timer is set or reset to T=0, and method 300 returns to step 302 for continued monitoring. This reset behavior filters out transient excursions and preserves system resources for evaluating persistent anomalies.

If the condition at step 304 is satisfied, the system proceeds to step 308, where the timer is allowed to run. Monitoring continues to determine whether the system remains within any of the predefined bands for a time interval sufficient to warrant action.

At step 310, the controller checks whether the monitored parameters fall within the first composite threshold band, as defined in Table 5:

$$Temp\_L1 \leq Temp\_NFT < Temp\_L2 ( e . g . , 100 - 120 ° C . ) ;$$

$$I\_L1 \leq I\_NFT < I\_L2 ( e . g . , 70 - 80 \% ) ; and$$

$$V\_L2 < V\_NFT \leq V\_L1 ( e . g . , 118 - 119 V ) .$$

If all three conditions are satisfied, the controller proceeds to step 312, where it evaluates whether the condition has persisted for at least T1 (e.g., 20 minutes). If so, the method proceeds to step 314 to execute Action 13.

Action 13 involves issuing a moderate imbalance notification, indicating that multiple indicators of transformer stress are active. The controller 30 may transmit an indication to a user interface, activate visual or audible alerts, and optionally initiate preliminary load-balancing routines. This may include phase-level adjustments, re-prioritization of controllable loads, or subtle changes to DER coordination.

If the condition at step 310 is not satisfied, the system proceeds to step 316, where it checks whether the measured parameters fall within a second, more elevated band:

$$Temp\_L2 \leq Temp\_NFT < Temp\_L3 ( e . g . , 120 - 130 ° C . ) ;$$

$$I\_L2 \leq I\_NFT < I\_L3 ( e . g . , 80 - 90 \% ) ; and$$

$$V\_L3 < V\_NFT \leq V\_L2 ( e . g . , 116 - 117 V ) .$$

If all three parameters remain within this intermediate range, the controller 30 evaluates persistence time at step 318. If the condition persists for at least T2 (e.g., 5 minutes), Action 14 is triggered at step 320.

Action 14 escalates the system's mitigation response. In this scenario, the NFT 14 is nearing thermal and electrical limits, and undervoltage conditions may affect load reliability. The HEMS controller 30 may initiate escalated load shedding routines, activate phase-balancing protocols, or preemptively disengage selected circuits. The system may concurrently intensify user notifications and log diagnostic markers for ongoing analysis. If applicable, backup DERs may be requested to increase output to stabilize voltage and alleviate load burden.

If neither of the above bands are satisfied, the system proceeds to step 322, where it determines whether the NFT 14 is experiencing a compounded escalated condition across all parameters:

$$Temp\_NFT \geq Temp\_L3 ( e . g . , \geq 130 ° C . ) ;$$

$$I\_NFT \geq I\_L3 ( e . g . , \geq 90 \% ) ; and$$

$$V\_NFT \leq V\_L3 ( e . g . , \leq 116 V ) .$$

If this condition is satisfied and remains persistent for longer than T3 (e.g., 1 minute), as checked at step 324, the system initiates Action 15 at step 326.

Action 15 is a protective system shutdown. The controller 30 may open relay 16 to fully isolate the NFT 14 from system conductors. A DTC may be logged, and the user may be presented with a high-priority alert identifying the root causes of the shutdown (e.g., excessive temperature, critical current draw, and undervoltage). The system may also lock out further energization attempts until temperatures normalize or until a manual reset is performed by authorized personnel.

If none of the threshold bands are satisfied, the system returns to step 304, continuing to monitor for onset of a composite fault condition.

The composite logic routines described above, illustrated in FIGS. 5 and 6 and defined by the thresholds in Tables 4 and 5, provide enhanced diagnostic and control capabilities by evaluating multiple stress indicators simultaneously. Whereas earlier routines (FIGS. 2-4) considered individual parameters such as current, temperature, or voltage in isolation, the composite methods evaluate combinations of these parameters to detect compound fault scenarios and initiate tiered system responses with greater accuracy and relevance.

By considering multiple conditions to be satisfied (e.g., elevated temperature and excessive current draw and a corresponding voltage drop), the system filters out false positives that might otherwise arise from a single transient metric. This layered analysis helps prioritize corrective actions in cases where the NFT 14 is not only overloaded thermally or electrically, but may also susceptible to undervoltage instability or asymmetric load degradation.

Each composite band, defined by adjacent threshold ranges and associated persistence times, provides for an appropriate level of intervention to be selected by the HEMS controller 30. At lower levels, composite notifications such as Actions 10 and 13 allow the system to preemptively adjust load configurations, redirect DER output, or notify users of developing stress conditions. As conditions escalate, subsequent actions (e.g., Actions 11, 12, 14, and 15) provide for more assertive interventions, such as load shedding, circuit isolation, or full NFT shutdown, all triggered in response to multi-dimensional fault detection rather than single-variable anomalies.

The algorithms, methods, or control routines described herein may be implemented by, or delivered to, one or more processing devices, such as a dedicated electronic controller, programmable control module, or distributed computing architecture. For example, in the context of a home energy system, such processing devices may include a home energy management system (HEMS) controller configured to execute voltage, temperature, or current monitoring logic associated with the neutral-forming transformer (NFT). These algorithms may be embodied as instructions stored on non-transitory machine-readable media, including non-writable storage such as read-only memory (ROM), or writable storage such as random-access memory (RAM), solid-state drives, magnetic media, or optical media. Execution of these instructions may occur through software objects, firmware, or combinations thereof. Alternatively or additionally, the disclosed functionality may be implemented, in whole or in part, using suitable hardware structures such as application-specific integrated circuits (ASICs), field-programmable gate arrays (FPGAs), digital state machines, or other logic devices capable of performing control tasks or responding to sensor inputs. In some embodiments, multiple control layers may be distributed across system components and coordinated to monitor operating parameters and execute composite control logic as described herein.

Although illustrative embodiments have been described, the scope of protection afforded by this disclosure is not limited to the specific examples provided. Rather, the embodiments are intended to be illustrative of concepts that may be implemented in various forms consistent with the claims. The terminology used herein is descriptive and not limiting, and structural or functional variations may be made without departing from the general principles set forth. For example, references to a “controller” may include a centralized controller, multiple distributed control modules operating in coordination, or a combination thereof. Control logic described as performed by a single controller may, in some implementations, be divided among multiple devices communicating via wired or wireless connections using established communication protocols.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. As such, embodiments described as less desirable than other embodiments or prior art implementations with respect to one or more characteristics are not outside the scope of the disclosure and may be desirable for particular applications.

What is claimed is:

1. A method of operating a home energy system that includes a neutral-forming transformer (NFT), the method comprising:
upon an operating parameter associated with the NFT exceeding a first value for at least a first duration, performing a first control response; and
upon the operating parameter exceeding a second value different than the first value for at least a second duration shorter than the first duration, performing a second control response different from the first control response.

2. The method of claim 1, wherein the operating parameter comprises a current drawn through the NFT.

3. The method of claim 1, wherein the operating parameter comprises a temperature of the NFT.

4. The method of claim 1, wherein each of the first and second values includes a relative value associated with an operating capacity of the NFT.

5. The method of claim 1, wherein the first control response comprises generating a user-facing notification.

6. The method of claim 1, wherein the second control response comprises effecting a load-balancing redistribution associated with the NFT.

7. The method of claim 1, further comprising:
upon the operating parameter exceeding a third value greater than the second value for at least a third duration shorter than the second duration, performing a third control response different from the first and second control responses.

8. The method of claim 7, wherein the third control response comprises isolating the NFT from one or more electrical conductors.

9. A home energy control system comprising:
a controller programmed to, upon a temperature and a voltage associated with an NFT of the home energy control system satisfying a first condition for at least a first duration, toggle loads associated with the NFT or shift load priority across conductors associated with the NFT, and upon the temperature and the voltage satisfying a second condition different than the first condition for at least a second duration shorter than the first duration, open an NFT relay of the home energy control system.

10. The home energy control system of claim 9, wherein the temperature and the voltage are measured at one or more sensors at or proximate to an enclosure of the NFT.

11. The home energy control system of claim 9, wherein the first condition comprises temperature between 100° C. and 120° C., and voltage between 119 V and 118 V.

12. The home energy control system of claim 9, wherein the second condition comprises temperature greater than 130° C., and voltage less than or equal to 116 V.

13. A home power distribution system comprising:
a housing including a neutral-forming transformer (NFT), one or more sensors configured to sense operating parameters associated with the NFT, and a controller configured to adjust a load distribution associated with the home power distribution system when the operating parameters satisfy a first condition for at least a first duration and to open an NFT relay when the operating parameters satisfy a second condition different than the first condition for at least a second duration shorter than the first duration.

14. The home power distribution system of claim 13, wherein the first condition comprises temperature between 100° C. and 120° C., and voltage between 119 V and 118 V.

15. The home power distribution system of claim 13, wherein the second condition comprises temperature greater than 130° C., and voltage less than or equal to 116 V.

16. The home power distribution system of claim 13, wherein the operating parameters include a current associated with the NFT and wherein the first condition comprises current greater than or equal to 70% of a rated current of the NFT.

17. The home power distribution system of claim 13, wherein the operating parameters include a current associated with the NFT and wherein the second condition comprises current greater than or equal to 90% of a rated current of the NFT.

18. The home power distribution system of claim 13, wherein the controller is configured to inhibit closing of the NFT relay until the operating parameters achieve recovery values.
